(19) United States
(12) Patent Application Publication
(10) Pub. No.: US 2026/0197194 A1
(43) Pub. Date: Jul. 9, 2026

(54) ONLINE MEETING SCREEN SHARE WITH AUTOMATED FOCUS TRACKING AND ALIGNMENT

(71) Applicant: International Business Machines Corporation, Armonk, NY (US)

(72) Inventors: Jing Ren, Beijing (CN); Zhao Yu Wang, BEIJING (CN); Jing Wen Chen, BEIJING (CN); Yi Jie Ma, BEIJING (CN); Xizhuo Zhang, Beijing (CN); Peng Hui Jiang, Beijing (CN)

(21) Appl. No.: 19/009,123

(22) Filed: Jan. 3, 2025

(51) Int. Cl. H04L 12/18; G06F 3/04812; G06F 3/16; G06F 40/20

(52) U.S. Cl. CPC H04L 12/1822; G06F 3/04812; G06F 3/167; G06F 40/20

(57) ABSTRACT

Mechanisms are provided for performing automated focus location tracking and alignment for screen sharing during real-time online meetings/conferencing. The mechanisms initiate, on a presenter computing device, a screen sharing functionality of a real-time online meeting application. The mechanisms execute a focus location tracking tool on the presenter computing device that tracks a user's focus location based on user inputs to the presenter computing device to thereby generate user focus location data. The mechanisms augment a shared screen data stream of the real-time online meeting application with the user focus location data which is streamed to one or more other participant computing devices along with the shared screen data stream. The one or more participant computing devices process the user focus location data to maintain the user's focus location within a display range of a shared screen portion of a display of the one or more participant computing devices.

### BACKGROUND

The present application relates generally to a data processing apparatus

and method and more specifically to a computing tool and computing tool operations/functionality for online meeting screen share with automated focus tracking and alignment.

Increasingly, collaboration between individuals is performed via online meeting or web conference software and services, their personal or work computing devices, and local or wide area data networks. Such technology allows individuals that are widely dispersed physically or geographically, or who otherwise cannot be physically present in the same room as other participants in the online meeting, to converse and interact with each other as if they were physically present in the same room.

As part of this online meeting capability, individuals are often permitted to share their screens, meaning that an individual is able to bring up a view of a graphical user interface (GUI) screen or window, and share that visual representation of the GUI screen or window with other participants in the meeting. The other participants will have the representation of the GUI screen or window streamed to their computing devices where it will be rendered in a portion of the online meeting software output on their display screens. The stream of the screen share allows the other participants to see the sharing participant's manipulations and interactions with the shared screen.

### SUMMARY

This Summary is provided to introduce a selection of concepts in a

simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises initiating, on a presenter computing device, a screen sharing functionality of a real-time online meeting application. The method further comprises executing a focus location tracking tool on the presenter computing device that tracks a user's focus location based on user inputs to the presenter computing device to thereby generate user focus location data. Moreover, the method comprises augmenting a shared screen data stream of the real-time online meeting application with the user focus location data which is streamed to one or more other participant computing devices along with the shared screen data stream. The one or more participant computing devices process the user focus location data to maintain the user's focus location within a display range of a shared screen portion of a display of the one or more participant computing devices.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives

and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is a block diagram of an automated focus tracking and alignment screen sharing tool in accordance with one illustrative embodiment;

FIG. 3 is an example diagram illustrating an automated screen sharing with focus tracking and alignment in accordance with one illustrative embodiment; and

FIG. 4 is an example flowchart outlining an example operation of an automated focus tracking and alignment screen sharing tool in accordance with one illustrative embodiment.

### DETAILED DESCRIPTION

The illustrative embodiments provide an improved computing tool and

improved computing tool operations/functionality for online meeting screen share with automated focus tracking and alignment.

As noted above, online meeting or conferencing is a widely used technology in modern collaborations between individuals. While these technologies provide great capabilities for allowing individuals to interact with each other remotely, they still have a number of drawbacks. One such drawback is in the way that screen sharing is implemented with these technologies, especially when one recognizes that the online meeting/conferencing may be performed with a wide variety of different types of computer equipment. That is, participants to an online meeting or conference can use a laptop, desktop computer, mobile smart phone, tablet computer, personal digital assistant computing device, or the like. Each of these different types of computing equipment have different configurations and characteristics. For example, each type of computing device may have a different screen size, different resolution capabilities for its display, and the like.

The differences in computing device capabilities for rendering screens of an online meeting or conference may lead to a situation where a presenter participant that is sharing their screen with the other participants may have a higher display resolution, larger screen dimensions, or other display characteristics that differ from the other participant computing devices. For example, one or more of the other participant computing devices may have lower resolution capabilities, smaller screen sizes, or the like. This may cause these other participants to have difficulty viewing shared contents of a shared screen clearly. That is, shared contents may be viewable on devices having relatively larger display sizes, such as a desktop computer display device, laptop display, or the like, but may not be viewable when rendered on a relatively smaller size display, such as on a mobile smartphone or the like.

While these other participants may use zoom capabilities to zoom-in to the shared screen representation on their computing devices, often such zooming-in causes a loss of focus on the screen. That is, due to the display size constraints, the focus location may, after zooming in to increase font size and readability of a shared screen, be located outside of the display range of the smaller size display devices. This may lead to frustration on the part of the participant while they have to try to manipulate the display of the shared screen on their computing device to try to re-focus on what the presenter may be focusing on, e.g., where the presenter's cursor may be pointing, during the online meeting.

Thus, there is a need to improve the screen share functionality of online meeting/conferencing software or services to perform focus tracking and automatic alignment for participant computing devices taking into consideration the differences in display characteristics of the participant computing devices. The illustrative embodiments provide a computing tool and computing tool operations/functionality to provide such focus tracking and automatic alignment for participants of an online meeting/conference. The illustrative embodiments operate to track a presenter's cursor, pointer, or other user interface element used to focus participant attention as well as performs voice input analysis to keep shared screen focus on the portions of the shared screen that the presenter is referencing during the online meeting/conference. This tracking information is streamed with other screen sharing data to the participant computing devices which render their outputs on the corresponding displays of the participant computing devices to maintain focus on the identified location while taking into consideration the participant device's display characteristics.

In some illustrative embodiments, when a participant joins an online meeting or conference, the participant can select a focus auto-follow tracking mode of operation, this functionality may be set in a user profile specifying online meeting/conference preferences, this functionality may be automatically enabled for all participants by the online meeting/conferencing software, or the like. If the user has selected to not enable this functionality, then the online meeting/conference (hereafter simply referred to as the online meeting) is conducted in a manner generally known in the art with regard to this particular participant. Thus, for different participants, the functionality may be enabled/disabled as desired. In some cases, the host for the online meeting may set the setting with regard to this functionality for all participants, who are deemed to agree to these settings based on their agreement to join the online meeting itself.

Assuming the functionality is enabled for a given participant, when the presenter, i.e., the participant who chooses to share their screen with the other participants, starts to perform screen sharing with the other participants, a focus detection and tracking tool identifies the focus point (x, y). This focus point is transmitted along with the video stream of the shared screen. Various mechanisms may be used by the focus detection and tracking computer model to identify the focus point (x, y). In some illustrative embodiments, the focus detection and tracking computer model may determine the focus point (x, y) based on the presenter's pointer cursor location on the screen and a reference location, e.g., the center of the portion of the presenter's display screen that is being shared. The rendering software of the presenter's computing device has the information for the location of the pointer cursor in order to render the pointer cursor on the presenter's screen. This location may change dynamically as the presenter moves their pointer device, e.g., computer mouse, trackball, joystick, or the like, and the presenter's computing device has driver software and the like to keep track of this location. This information may also be maintained in real-time by the focus detection and tracking computer model which may transmit this information along with the video stream as part of the streaming of the shared screen data. That is, the shared screen data merely represents the pixels of the shared screen so that the same image may be reproduced on participant computing devices. In addition to this pixel information, additional pointer cursor location data may be provided that specifically identifies the focus point in the pixel information.

In some illustrative embodiments, this information may be normalized relative to the presenter's computing device display characteristics, e.g., screen size, screen resolution, and the like, prior to transmission. In this way, a normalized pointer cursor location is transmitted and can be used by participant computing devices having differing display characteristics, e.g., screen size, screen resolution, and the like, through a conversion or adaptation to the participant computing device's individual display characteristics. In other illustrative embodiments, the adaptation of the focus point on the presenter's computing device to a corresponding point on the participant computing device shared screen display portion may be performed at the participant computing device by a mapping of the focus point (x, y) to a corresponding point of the shared screen display portion of the participant computing device based on the center location of the shared screen display portion of the participant computing device.

When the presenter's input in the shared screen is to an input field, box, command line, or the like, the location of the input cursor, e.g., text entry cursor, highlighted box, or the like, may be used by the focus detection and tracking tool as the tracked focus location and recorded as the focus point (x, y). Thus, if the presenter uses a keyboard or other input device that does not manipulate the pointer cursor on the screen, the focus point may be determined to be where the most recent input by the presenter is targeted, whether that is a text input field, highlighted menu option, or the like. This allows for various types of input devices to be used to manipulate the shared screen and have those inputs still be used to identify where the presenter's focus is when sharing their screen. In order to identify where these locations are, the portion of the shared screen that is changed from one time point to another may be determined from the rendering software and input device driver software so as to identify where presenter inputs are targeting changes in the shared screen.

In the event that the presenter is not providing inputs to the shared screen via a pointing device or other input device that manipulates a portion of the shared screen, the presenter's voice input via a microphone may be processed by the focus detection and tracking tool to determine the most likely focus point in the shared screen that the presenter is speaking about. In order to perform such tracking, the a focus detection and tracking tool may utilize voice-to-text software, computer natural language processing (NLP), and language models (LMs) or fine-tuned large language models (LLMs) to convert the voice input to a textual translation, extract features from the textual translation, and process the extracted features via a LM/LLM to understand the content of the voice input and detect a matching portion of the shared screen that corresponds to what the presenter is speaking about, which will then be used to determine the focus point location (x, y). To identify the focus point location on the screen itself on the presenter side, an optical character reading or other screen scanning technique may be used to scan the shared contents and record the location of meaningful words or sentences, graphical elements, and the like, which may then be stored, or have their corresponding tags or other identifiers stored, in a metadata data structure. Then when the presenter is speaking about a location, the NLP/LM determines the content of the presenter's speech input as discussed above, and may then search the metadata data structure of the screen for the most relative contents and get the location of (x, y), where the most relevant may be based on a textual similarity between the spoken content of the presenter and the text/tags of the elements of the screen.

Of course, illustrative embodiments of the present invention may use any combination of the above methodologies to track the focus location of the presenter and communicate that focus location to the participant computing devices as additional data or metadata of the data stream for the shared screen portion of the online meeting. The focus detection and tracking tool, in some illustrative embodiments, may monitor for each of these different types of focus identification inputs and may resolve them in configured order to identify the focus location. That is, in some illustrative embodiments, pointer cursor location may be considered a highest priority, followed by input cursor location, and then voice input analysis based location. Other methodologies may also be used to prioritize these different types of focus identification inputs and/or resolve any conflicts between these focus identification inputs, e.g., if the user is speaking about a location in the shared screen at approximately the same time as the pointer cursor is being manipulated, then such prioritizations may be used to distinguish which inputs to use to identify the current focus location.

At the participant computing devices that have a focus auto-follow mode of operation enabled, a center location of the shared screen display (x′, y′) is determined and used along with the focus location (x, y) streamed by the presenter computing device to maintain the focus location (x, y) in the center of the shared screen display on the participant's computing device. In the case of a normalized focus location (x, y) being provided by the presenter computing device, then the normalized focus location may be used by a local focus tracking agent of the online meeting software to directly map to a point on the shared screen display of the participant computing device using the local coordinate system of the participant computing device's shared screen portion. For example, the same (x, y) location relative to the reference point on the presenter' computing device's shared screen (e.g., (x0, y0)), which may be a difference between the reference point and the location, may be used to determine the same location relative to a coordinate system used to render the shared screen portion on the participant computing device.

In the case that a normalized location is not utilized, then the participant computing device's shared screen functionality of the online meeting software may be augmented to include a local focus tracking agent that maps the focus location (x, y) to a center point of the shared screen portion on the participant computing device display. That is, the participant computing device aligns the focus location (x, y) with the center point (x′, y′) via a coordinate mapping algorithm that maps points in the coordinate system using relative distances to reference points, for example. It should be appreciated that, on the presenter side, different screen sizes and resolutions of presenter computing devices and participant computing devices do not need to be taken into consideration. To the contrary, all that is needed is to obtain the focus point location (x, y) and send that information along with the data stream. On the participant side, the participant computing device receives this focus location (x, y) from the presenter side and aligns the focus point location with its own screen center, thereby taking into account that participant computing device's own screen size and current resolution. Adjustments to the screen based on the zoom-in or zoom-out ratio selected by user may then be made similar to existing zoom-in and zoom-out mechanisms. However, if the zoom-in or zoom-out mechanisms cause the focus point location to be moved outside the screen of participant computing device, then a re-alignment is triggered.

It should be appreciated that the alignment of the focus location to the center point of the participant computing device's display of the shared screen may be updated continuously during the sharing of the screen by the presenter, or may be performed in response to certain predetermined conditions. For example, these predetermined conditions may comprise the presenter's focus location moving outside of the display range of the participant's display screen size and current resolution. For example, when the presenter's focus point location changes, e.g., via a pointer cursor movement, input cursor movement, or voice input determined to be referencing a different focus point, the new focus point may be determined and compared to the current display range of the shared screen portion of the participant computing device's display to determine if the new focus point has moved outside of this display range. If the new focus point is within the display range, no update of the centering of the focus location needs to be performed and the current display region of shared screen display is kept, allowing the presenter's focus location to move within the display range without having to recenter the focus location. If the new focus point is not inside of the participant's display range of the current shared screen portion, then a new alignment of the focus point (x, y) to the center point (x′, y′) of

the shared screen portion may be performed to thereby update the display range to be centered around the new focus point.

This process may be repeated continuously during the time period that the presenter is sharing their screen, and may be performed separately on each participant computing device relative to that participant computing device's individual display characteristics, e.g., screen size, resolution, size of shared screen display portion, and the like. Moreover, this process may be performed when the responsibilities of presenting and sharing screens moves from one participant to another. Thus, as different participants choose to share their individual screens, this process of sharing and tracking focus location may be initiated and performed for each participant that shares their screen with the other participants.

It should be appreciated that at the participant computing device, should a participant zoom-in or zoom-out of the shared screen display portion, the local focus tracking agent may perform the alignment of the focus location with the center location of the shared screen display as the zooming in/out is performed so as to maintain the focus location at the center of the shared screen display. In this way, the presenter's focus location is not lost due to zooming in/out on the participant side of the shared screen experience.

Thus, the illustrative embodiments provide an improved computing tool and improved computing tool operations/functionality for tracking and maintaining the focus location of a presenter's shared screen within the display range of a participant computing device's shared screen portion of their display. The illustrative embodiments continuously and dynamically record the focus point location (x, y) on presenter's side and shares that focus point location along with the shared screen data with participants that have focus auto-follow mode enabled. Pointer cursor, input cursor, and artificial intelligence (AI) based voice input analysis may be performed to determine the focus location. At the participant side, a local focus tracking agent operates to update the focus location to be centered in the shared screen portion of the display on the participant computing device based on the focus point location information streamed with the shared screen data. As a result, the presenters with focus auto-follow enabled do not lose the presenter's focus point when the focus point changes or when the participants zoom in/out of the shared screen portion of their displays.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a focus detection and tracking along with real-time shared screen focus location updating in online meetings and conferences. The improved computing tool implements mechanism and functionality, such as a focus detection and tracking tool, which cannot be practically performed by human beings either outside of, or with the assistance of, a technical environment, such as a mental process or the like. The improved computing tool provides a practical application of the methodology at least in that the improved computing tool is able to maintain the focus location of a presenter's interactions with a shared screen in participant computing device displays of the shared screen so that focus is not lost even when the focus location changes or the participants manipulate their local displays of the shared screen.

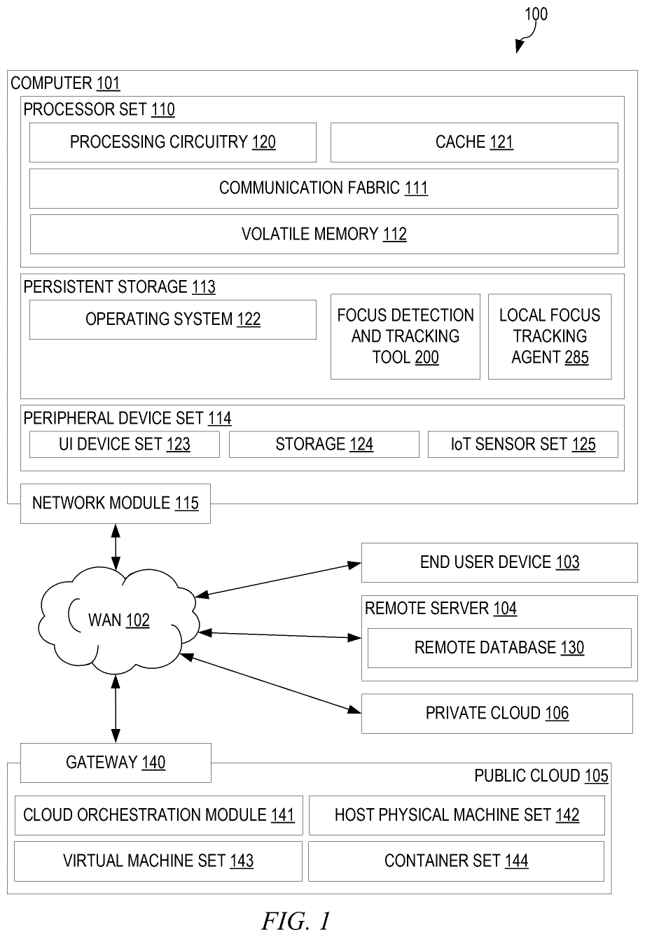

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as focus detection and tracking tool 200 and local focus tracking agent 285. In addition to focus detection and tracking tool 200 and local focus tracking agent 285, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, focus detection and tracking tool 200, and local focus tracking agent 285, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in focus detection and tracking tool 200 and local focus tracking agent 285 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in focus detection and tracking tool 200 and local focus tracking agent 285 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a focus detection and tracking tool 200 and local focus tracking agent 285. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates tracking of presenter focus locations in shared screens during real-time online meetings/conferences and maintaining the focus location in participant computing device renderings of the shared screen.

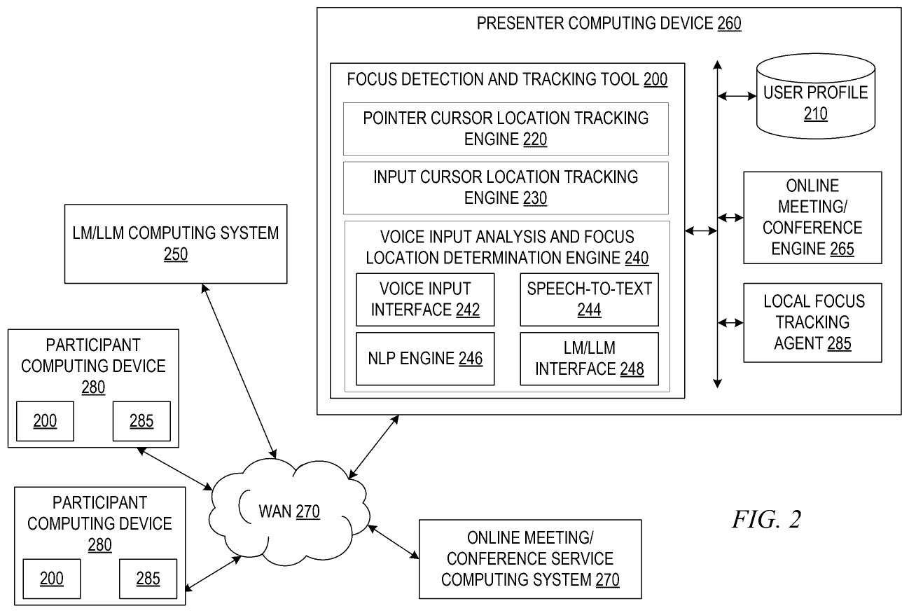

FIG. 2 is a block diagram of an automated focus tracking and alignment screen sharing tool in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that screen sharing during real-time online meetings/conferences is performed, and providing a specific solution that implements focus detection and tracking and local focus updating for shared screens, which cannot be practically performed by human beings as a mental process and is not directed to organizing any human activity.

As shown in FIG. 2, the focus detection and tracking tool 200 comprises a user profile storage 210, a pointer cursor location tracking engine 220, an input cursor location tracking engine 230, and a voice input analysis and focus location determination engine 240. The voice input analysis and focus location determination engine 240 further comprises a voice input interface 242, speech-to-text converter 244, a computer natural language processing (NLP) engine 246, an language model (LM)/large language model (LLM) interface 248. While the focus detection and tracking tool 200 is shown in detail only with regard to the presenter computing device 260, it should be appreciated that during a real-time online meeting/conference, any participant computing device 260, 280 is potentially a presenter computing device when the responsibilities for screen sharing are moved from one participant to another. Thus, each participant computing device 260, 280 may be configured in a similar manner to include the focus detection and tracking tool 200, as well as a local focus tracking agent 285. When the participant computing device is operating as a presenter computing device, the focus detection and tracking tool 200 operates to track the presenter's focus location and distribute this focus location to the other participant computing devices 280. When the participant computing device is operating as a participant and not a presenter, the local focus tracking agent 285 may operate based on streamed focus location information to update the shared screen portion of a display to maintain the focus location within a display range of the shared screen portion.

The presenter computing device 260 and other participant computing devices may further comprise online meeting/conference engine 265 which provides the computer logic for conducing real-time online meetings/conferences over one or more data networks 290. The engine 265 may be a client software component to an online meeting/conference service computing system 270 and provides real-time meeting/conference capabilities by streaming data between the participant computing devices 260, 280 of an online meeting/conference session via the one or more data networks 290 connecting these devices. Real-time online meeting/conferencing software and services are generally known in the art and thus, a more detailed explanation of how they operate is not provided herein. Examples of such real-time online meeting/conferencing software may include Zoom® (a trademark of Zoom Video Communications, Inc.), Microsoft Teams® (a trademark of Microsoft Corporation), Cisco Webex® (a trademark of Cisco Technology, Inc.), and the like. The focus detection and tracking tool 200 and the local focus tracking agent 285 operate in conjunction with such online meeting/conference engine 265 and online meeting/conference service computing system 270 to conduct real-time online meetings/conferences and provide the enhanced and extended capabilities of the illustrative embodiments to improve the operation of such real-time online meetings/conferences with regard to shared screen presentation and focus location tracking.

The participant computing devices 260, 280 may be of various types, e.g., laptops, desktop computer, mobile smartphones, tablet computers, personal digital assistant devices, and the like, and may of different makes and models with different display capabilities and display screen characteristics, e.g., screen size, resolution capabilities, and the like. For example, some participants to a real-time online meeting may be participating from mobile smartphones, others may be participating from desktop computers, and still others may be participating from tablet computers. Each of these various devices may be configured, such as when installing the online meeting/conference engine 265 on these devices, to implement the focus detection and tracking tool 200 and/or local focus tracking agent 285. For example, these elements 200 and 285 may be sub-components of the online meeting/conference engine 265 in some illustrative embodiments.

The user profile storage 210 of the focus detection and tracking tool 200 stores the user profile for the user of the participant computing device 260, 280. This user profile may specify preferences that are to be used with each real-time online meeting/conference, one-time preferences, or the like, along with any other suitable user specific information for configuring the participant computing device 260, 280 for use with real-time online meetings/conferences, e.g., login information, display name information, preferences regarding camera enablement, microphone enablement, screen text sizes, etc. In accordance with the illustrative embodiments, one preference that may be specified in the user profile is whether or not to enable focus auto-follow mode when the participant computing device 260, 280 is operating as a participant (not a presenter) during the real-time online meetings/conferences conducted via the online meeting/conference engine 265. This may be set as a default setting in the user's profile and may be overridden on a case-by-case basis by the user for particular real-time online meetings/conferences, such as when the user joins the meeting/conference and selects a setting to override this default setting, e.g., enabling/disabling the focus auto-follow functionality. This setting or override of the setting may be used to enable/disable the functionality of the local focus tracking agent 285, for example.

Thus, when a participant computing device 260, 280 joins an online meeting or conference via their online meeting/conferencing engine 265, the participant can select a focus auto-follow tracking mode of operation and/or this setting may be retrieved from the user profile specifying online meeting/conference preferences. As a result, the functionality of the local focus tracking agent 285 may then be enabled/disabled for this particular user as a participant to the real-time online meeting.

In some illustrative embodiments, this functionality may be automatically enabled for all participants by the online meeting/conference by a host of the meeting/conference. That is, hosts may be given super-privileges that may override individual participant preferences as desired. Thus, while a participant's preferences may be to not enable focus auto-follow mode, the host may instead enable such functionality to ensure that each participant remains focused on the presenter's focus location, for example. When the focus auto-follow functionality is disabled, the online meeting is conducted in a manner generally known in the art with regard to this particular participant, i.e., the focus auto-follow capabilities of the local focus tracking agent 285 are not implemented. When enabled, however, the local focus tracking agent 285 performs the operations described herein to maintain the focus location of a presenter that is sharing their screen within a display range of a shared screen portion of the participant's computing device's display. Each individual participant computing device 260, 280 may have this functionality either enable or disabled as desired by the participants and/or host and thus, the enablement/disabling may be different for different participants of the same real-time online meeting.

When a particular participant computing device 280 is designated a presenter by providing it with privileges to share its screen with other participant computing devices 280 of the real-time online meeting, that participant computing device 280 then becomes a presenter computing device 260. The presenter computing device 260 may then start to perform screen sharing with the other participant computing devices 280 through the screen sharing functionality embedded in the online meeting/conferencing engine 265. This in turn initiates the operation of the focus detection and tracking tool 200 which may be separate from, or embedded with, the screen sharing functionality. The focus detection and tracking tool 200 identifies the presenter's focus point (x, y) within the shared screen on the presenter computing device 260 and transmits this focus point information along with the video stream of the shared screen to the other participant computing devices 280 via the online meeting/conference engine 265 and the one or more data networks 290.

Various mechanisms may be used by the focus detection and tracking tool 200 to identify the focus point (x, y) as noted above. These mechanisms may include a pointer cursor location detection and tracking by the pointer cursor location tracking engine 220, for example. The pointer cursor location tracking engine 220 may determine the focus point (x, y) based on the presenter's pointer cursor location on the screen of the presenter computing device 260, relative to a reference location, e.g., the center of the portion of the presenter's display screen that is being shared. The rendering software of the presenter's computing device 260 has the information for the location of the pointer cursor in order to render the pointer cursor on the presenter's screen, which may change dynamically as the presenter interacts with the graphical user interface (GUI) using any of a number of different pointer input devices or peripheral devices, such as a computer mouse, trackball, joystick, or the like. Driver software is used to communicate the detected movements of these devices and translate those movements into a graphical representation of a pointer cursor on the screen of the presenter's computing device 260. This information may also be captured and maintained in real-time by the focus detection and tracking tool 200 via the pointer cursor location tracking engine 220. The focus detection and tracking tool 200 may transmit this information along with the video stream, via the online meeting/conferencing engine 265, as part of the streaming of the shared screen data, e.g., as metadata to the shared screen data stream.

As previously noted above, in some illustrative embodiments, this information may be normalized by the pointer cursor location tracking engine 220 relative to the presenter's computing device 260 display characteristics, e.g., screen size, screen resolution, and the like, prior to transmission by the focus detection and tracking tool 200 to the other participant computing devices 280. In this way, a normalized pointer cursor location is transmitted and can be used by participant computing devices 280 having differing display characteristics, e.g., screen size, screen resolution, and the like, through a conversion or adaptation to the participant computing device's individual display characteristics. In other illustrative embodiments, the adaptation of the focus point on the presenter's computing device 260 to a corresponding point on the participant computing device 280 shared screen display portion may be performed at the participant computing device 280, such as via the participant computing device's own local focus tracking agent 285, by a mapping of the focus point (x, y) to a corresponding point of the shared screen display portion of the participant computing device 280. This may be performed, for example, based on the center location of the shared screen display portion of the participant computing device 280.

The focus detection and tracking tool 200 may further include the input cursor location tracking engine 230 which operates to track the presenter's input that is not associated with the manipulation of a pointer input device or peripheral but through other input devices, such as a keyboard, for example. When the presenter's input in the shared screen is to an input field, box, command line, or the like, the location of the input cursor, e.g., text entry cursor, highlighted box, or the like, may be detected by the input cursor location tracking engine 230 and used by the focus detection and tracking tool 200 as the tracked focus location and recorded as the focus point (x, y) which is then transmitted to the participant computing devices 280 along with the shared screen data stream. Thus, if the presenter uses a keyboard or other input device that does not manipulate the pointer cursor on the screen, the focus point may be determined to be where the most recent input by the presenter is targeted, whether that is a text input field, highlighted menu option, or the like.

In the event that the presenter is not providing inputs to the shared screen via a pointing device or other input device that manipulates a portion of the shared screen, the voice input analysis and focus location determination engine 240 may be utilized to capture and analyze a presenter's voice input via a microphone or other audio capture device. That is, the voice input analysis and focus location determination engine 240 may process the captured voice input to determine the most likely focus point in the shared screen that the presenter is speaking about. In order to perform such tracking, the voice input analysis and focus location determination engine 240 comprises a voice input interface 242 that operates in conjunction with a microphone or other audio capture device, and its corresponding driver software, to capture a digital representation of the presenter's voice input. A speech-to-text converter 244 may utilize known speech-to-text translation computer functionality to convert the voice input signals to a textual representation of the spoken words.

The textual representation of the voice input may then be provided to a computer natural language processing (NLP) engine 246 which performs natural language processing operations on the text to extract key terms/phrases from the text. These extracted key terms/phrases may be those corresponding to graphical user interface and display screen elements or other terms/phrases determined to be indicative of a focus of a presenter when sharing their screen with other participants in a real-time online meeting. The NLP engine 246 may be specifically configured, such as via curated resources, e.g., dictionaries, synonym databases, ontologies, and the like, to be specifically directed to the identification of terms/phrases for identifying presenter focus in shared screens.

The key terms/phrases identified by the NLP engine 246 may be utilized as a basis for determining the focus location of the presenter by correlating these terms/phrases with elements of a GUI or screen currently being shared by the presenter computing device 260 with the other participant computing devices 280. In order to perform this correlation, the voice input analysis and focus location determination engine 240 may utilize one or more language models (LMs) or large language models (LLMs) to interpret the key terms/phrases and determining what GUI elements or screen elements are being referenced. In some illustrative embodiments, the LM/LLM may be a pre-trained LM/LLM which is then fine-tuned for focus location determination using text extracted from voice input. That is, the LM/LLM may be fine-tune trained through prompts specifying the operation the LM/LLM is to perform and giving the context upon which the LM/LLM is to operate, where this context may be the key terms/phrases, for example. The prompt may further specify the format and type of output that the LM/LLM is to use and any tools that the LM/LLM may utilize to perform the operation. Thus, the large scale pre-training of the LM/LLM may be leveraged and fine-tuned to the specific task of correlating voice input with focus location of a presenter with regard to a shared screen.

While these engines 220, 230, and 240 are described as having separate operations based on different types of presenter inputs to the presenter computing device 260, and may operate independently of each other, in some illustrative embodiments one or more combinations of the above methodologies to track the focus location of the presenter and communicate that focus location to the participant computing devices 280 as additional data or metadata of the data stream for the shared screen portion of the online meeting may be utilized. The focus detection and tracking tool 200, in some illustrative embodiments, may monitor for each of these, or a subset of these, different types of focus identification inputs via the engines 220, 230, and 240 and may resolve them in order to identify the focus location. For example, in some illustrative embodiments, pointer cursor location may be considered a highest priority, followed by input cursor location, and then voice input analysis based location. In other illustrative embodiments, a different priority ordering may be utilized. Other methodologies may also be used to prioritize these different types of focus identification inputs and/or resolve any conflicts between these focus identification inputs, as noted above.

At the participant computing device 280 that have a focus auto-follow mode of operation enabled, the local focus tracking agent 285 determines the center location of the shared screen display (x′, y′) which it uses, along with the focus location (x, y) streamed by the presenter computing device 260 and received by the local focus tracking agent 285, to maintain the focus location (x, y) in a display region of the shared screen portion of the output on the participant computing device 280. In some illustrative embodiments, the operation of the local focus tracking agent 285 may operate to maintain the focus location at the center of the shared screen display on the participant's computing device 280.

In the case of a normalized focus location (x, y) being provided by the presenter computing device 260, then the normalized focus location may be used by the local focus tracking agent 285 to directly map to a point on the shared screen display of the participant computing device 280 using the local coordinate system of the participant computing device's shared screen portion. For example, the same (x, y) location relative to the reference point on the presenter' computing device's 260 shared screen (e.g., (x0, y0)), which may be a difference between the reference point and the location, may be used to determine the same location relative to a coordinate system used to render the shared screen portion on the participant computing device 280.

In the case that a normalized location is not utilized, then the local focus tracking agent 285 may operate to maps the focus location (x, y) to a center point of the shared screen portion on the participant computing device 280 display. That is, the participant computing device 280 aligns the focus location (x, y) with the center point (x′, y′) via a coordinate mapping algorithm that maps points in the coordinate system using relative distances to reference points, for example. Based on this mapping, the shared screen portion of the output on the participant computing device 280 may be adjusted to center the focus location (x, y) at the center point (x′, y′) or to at least maintain the focus location (x, y) with the display range around the center point (x′, y′) until the focus location (x, y) leaves that display range, at which point a re-centering may be performed based on the new focus location (x, y).

Tus, the local focus tracking agent 285, based on the streamed focus location information from the focus detection and tracking tool 200 of the presenter computing device 260, may continuously perform alignment of the focus location to the center point of the participant computing device's display of the shared screen. In response to the presenter's focus location moving outside of the display range of the participant computing device's display screen size and current resolution, the local focus tracking agent 285 may initiate a recentering of the shared screen portion to recenter the focus location at the center of the shared screen portion on the participant computing device 280.

For example, when the presenter's focus point location changes, e.g., via a pointer cursor movement, input cursor movement, or voice input determined to be referencing a different focus point, the new focus point may be determined by the focus detection and tracking tool 200 and streamed to the local focus tracking agent 285 on a participant computing device 280. The local focus tracking agent 285 compares this focus location to the current display range of the shared screen portion of the participant computing device's display to determine if the new focus point has moved outside of this display range, e.g., comparing the new focus locations coordinates (x, y), mapped to the shared screen portion, to the border coordinates of the shared screen to determine if one or both of the coordinates is above/below the coordinates of the border. If the new focus point is within the display range, no update of the centering of the focus location needs to be performed by the local focus tracking agent 285 and the current display region of shared screen display is kept, allowing the presenter's focus location to move within the display range without having to recenter the focus location. If the new focus point is not inside of the participant's display range of the current shared screen portion, then the local focus tracking agent 285 performs a new alignment of the focus point (x, y) to the center point (x′, y′) of the shared screen portion may be performed to thereby update the display range to be centered around the new focus point.

This process may be repeated continuously during the time period that the presenter is sharing their screen via their presenter computing device 260, and may be performed separately on each participant computing device 280 relative to that participant computing device's individual display characteristics, e.g., screen size, resolution, size of shared screen display portion, and the like. Moreover, this process may be performed when the responsibilities of presenting and sharing screens moves from one participant to another, thereby allowing different participants to share their screens at different times during the real-time online meeting/conference and having focus location tracking performed for each such instance of screen sharing.

It should be appreciated that at the participant computing device 280, should a participant zoom-in or zoom-out of the shared screen display portion, the local focus tracking agent 285 may perform the alignment of the focus location with the center location of the shared screen display as the zooming in/out is performed so as to maintain the focus location at the center of the shared screen display. In this way, the presenter's focus location is not lost due to zooming in/out or changing of the resolution of the screen on the participant side of the shared screen experience.

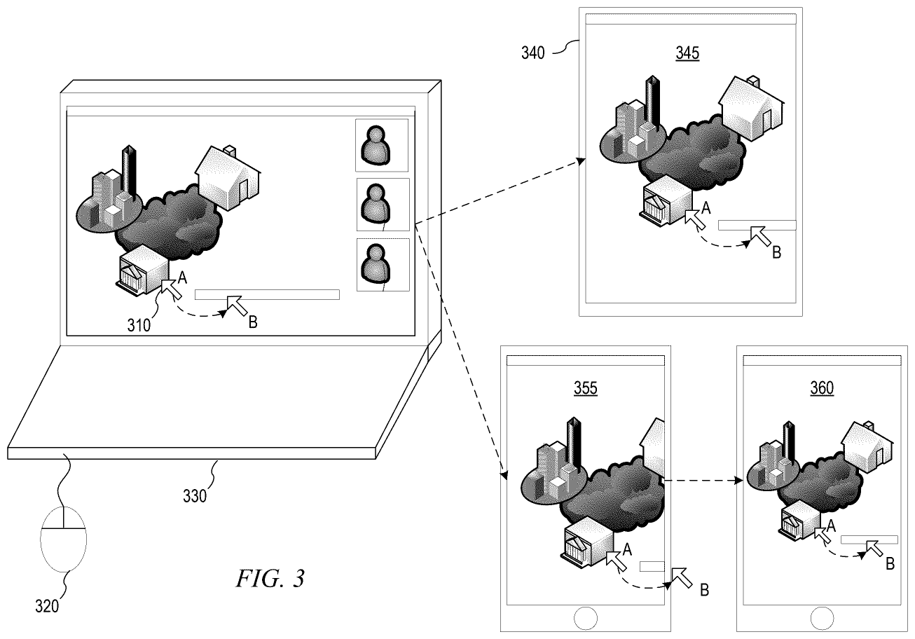

FIG. 3 is an example diagram illustrating an automated screen sharing with focus tracking and alignment in accordance with one illustrative embodiment. As shown in FIG. 3, the presenter moves their pointer cursor 310 within a display, which is being shared with other participant computing devices, from a first location A to a second location B. This change in focus location is detected by the focus detection and tracking tool 200 by using a pointer cursor location tracking engine that monitors the input from a pointing device 320 associated with the presenter computing device 330.

On a first participant computing device 340, the local focus tracking agent 285 operates to represent the change in focus location within the shared screen portion 345 of the output of the first participant computing device 340. As this change in focus location is still within the display region of the shared screen portion 345, no update or recentering of the focus location is needed. However, on a second participant computing device 350, it is determined by that device's local focus tracking agent 285 that the focus location has moved outside the display region of the shared screen portion 355. Thus, a recentering of the focus location is performed to move the focus location to the center of the shared screen portion, as depicted in image 360.

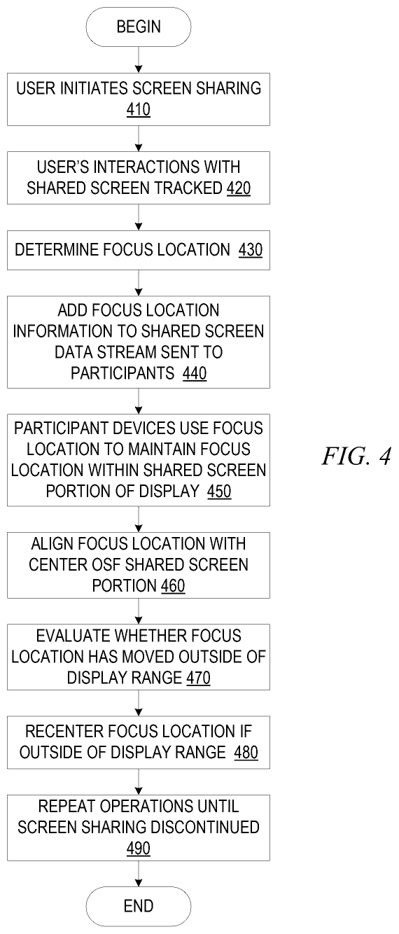

FIG. 4 is an example flowchart outlining an example operation of an automated focus tracking and alignment screen sharing tool in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

The operation outlined in FIG. 4 assumes a previous configuring and setting of preferences for focus location tracking and alignment. As shown in FIG. 4, the operation starts with a user initiating screen sharing via their real-time online meeting software (step 410). The user's interactions with the shared screen are tracked to determine portions of the shared screen manipulated by the user, e.g., pointer cursor movements, interaction with GUI elements such as text input fields, menus, and the like, and/or voice input directing attention to particular portions of the shared screen (step 420). Based on the user's interactions, a focus location is determined (step 430) and added to the shared screen data stream sent to participant computing devices (step 440). At the participant computing devices, the focus location information is used to maintain the focus location within a shared screen portion of a display of the participant computing device (step 450). This may involve both aligning the focus location with the center of the shared screen portion of the display at the participant computing device (step 460) and determining whether the focus location is outside of a display range given the particular participant device's display size (step 470) and making adjustments as necessary to recenter the focus location when the focus location is outside the display range (step 480). The operation continues while the sharing of the screen is continued and terminates once screen sharing is discontinued (step 490).

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
initiating, on a presenter computing device, a screen sharing functionality of a real-time online meeting application;
executing a focus location tracking tool on the presenter computing device that dynamically tracks a user's focus location based on user inputs to the presenter computing device to thereby generate user focus location data; and
augmenting a shared screen data stream of the real-time online meeting application with the user focus location data which is streamed to one or more other participant computing devices along with the shared screen data stream, wherein the one or more participant computing devices process the user focus location data to maintain the user's focus location within a display range of a shared screen portion of a display of the one or more participant computing devices.

2. The method of claim 1, wherein the focus location tracking tool tracks a user's cursor or pointer location in a shared screen portion of a display of the presenter computing device.

3. The method of claim 1, wherein the user input is a voice input, and wherein the focus location tracking tool tracks the user's focus location at least by:
converting the voice input to a textual representation by executing a speech-to-text application on the voice input;
extracting key terms or phrases from the textual representation by executing computer natural language processing on the textual representation; and
correlating the key terms or phrases with metadata specifying elements of a shared screen portion of a display of the presenter computing device.

4. The method of claim 1, further comprising enabling, for each participant computing device, focus tracking on the participant computing device to cause the participant computing device to maintain a focus location visible within a shared screen portion of the participant computing device during the real-time online meeting.

5. The method of claim 4, wherein the focus tracking is enabled on each of the participant computing devices based on a setting of a host computing device instructing each participant computing device to enable the focus tracking when the participant computing device joins the real-time online meeting.

6. The method of claim 1, further comprising, on at least one of the one or more participant computing devices:
processing the user focus location data to determine whether the user's focus location is within a display range of the shared screen portion of the display of the at least one participant computing device; and
in response to the user focus location being outside the display range of the shared screen portion of the display, automatically executing a recentering of the user's focus location within the display range of the shared screen portion of the display of the at least one participant computing device.

7. The method of claim 1, wherein the user's focus location is normalized to a screen size and screen resolution of the presenter computing device.

8. The method of claim 1, wherein the user inputs comprise at least one of a manipulation of a graphical user interface (GUI) element of a shared screen portion of the display on the presenter computing device, wherein the user's focus location is determined to be the GUI element location.

9. The method of claim 1, wherein a plurality of different user inputs may be received at approximately a same time, and wherein the focus location tracking tool on the presenter computing device dynamically tracks the user's focus location based on a predetermined prioritization of the plurality of different user inputs that are received at approximately a same time.

10. The method of claim 1, wherein the one or more participant computing devices process the user focus location data to maintain the user's focus location within a display range of a shared screen portion of a display of the one or more participant computing devices at least by centering the user's focus location at a center point of the display range of the shared screen portion and dynamically maintaining updated user focus locations at the center point of the display range of the shared screen portion.

11. A computer program product comprising:
one or more computer-readable storage media; and
program instructions stored on the one or more computer-readable storage media to perform operations comprising:
initiating, on a presenter computing device, a screen sharing functionality of a real-time online meeting application;
executing a focus location tracking tool on the presenter computing device that dynamically tracks a user's focus location based on user inputs to the presenter computing device to thereby generate user focus location data; and
augmenting a shared screen data stream of the real-time online meeting application with the user focus location data which is streamed to one or more other participant computing devices along with the shared screen data stream, wherein the one or more participant computing devices process the user focus location data to maintain the user's focus location within a display range of a shared screen portion of a display of the one or more participant computing devices.

12. The computer program product of claim 11, wherein the focus location tracking tool tracks a user's cursor or pointer location in a shared screen portion of a display of the presenter computing device.

13. The computer program product of claim 11, wherein the user input is a voice input, and wherein the focus location tracking tool tracks the user's focus location at least by:
converting the voice input to a textual representation by executing a speech-to-text application on the voice input;
extracting key terms or phrases from the textual representation by executing computer natural language processing on the textual representation; and
correlating the key terms or phrases with metadata specifying elements of a shared screen portion of a display of the presenter computing device.

14. The computer program product of claim 11, further comprising enabling, for each participant computing device, focus tracking on the participant computing device to cause the participant computing device to maintain a focus location visible within a shared screen portion of the participant computing device during the real-time online meeting.

15. The computer program product of claim 14, wherein the focus tracking is enabled on each of the participant computing devices based on a setting of a host computing device instructing each participant computing device to enable the focus tracking when the participant computing device joins the real-time online meeting.

16. The computer program product of claim 11, wherein the operations further comprise, on at least one of the one or more participant computing devices:
processing the user focus location data to determine whether the user's focus location is within a display range of the shared screen portion of the display of the at least one participant computing device; and
in response to the user focus location being outside the display range of the shared screen portion of the display, automatically executing a recentering of the user's focus location within the display range of the shared screen portion of the display of the at least one participant computing device.

17. The computer program product of claim 11, wherein the user's focus location is normalized to a screen size and screen resolution of the presenter computing device.

18. The computer program product of claim 11, wherein the user inputs comprise at least one of a manipulation of a graphical user interface (GUI) element of a shared screen portion of the display on the presenter computing device, wherein the user's focus location is determined to be the GUI element location.

19. The computer program product of claim 11, wherein a plurality of different user inputs may be received at approximately a same time, and wherein the focus location tracking tool on the presenter computing device dynamically tracks the user's focus location based on a predetermined prioritization of the plurality of different user inputs that are received at approximately a same time.

20. A computer system comprising:
a processor set;
one or more computer-readable storage media; and
program instructions stored on the one or more computer-readable storage media to cause the processor set to perform operations comprising:
initiating, on a presenter computing device, a screen sharing functionality of a real-time online meeting application;
executing a focus location tracking tool on the presenter computing device that dynamically tracks a user's focus location based on user inputs to the presenter computing device to thereby generate user focus location data; and
augmenting a shared screen data stream of the real-time online meeting application with the user focus location data which is streamed to one or more other participant computing devices along with the shared screen data stream, wherein the one or more participant computing devices process the user focus location data to maintain the user's focus location within a display range of a shared screen portion of a display of the one or more participant computing devices.
